(19) United States
(12) Patent Application Publication
(10) Pub. No.: US 2015/0092104 A1
(43) Pub. Date: Apr. 2, 2015

(54) STROBE DEVICE AND PHOTOGRAPHY DEVICE PROVIDED WITH SAME

(71) Applicant: Panasonic Intellectual Property Management Co., Ltd., Osaka (JP)

(72) Inventor: Takashi Umehara, Osaka (JP)

(21) Appl. No.: 14/394,760

(22) PCT Filed: Apr. 22, 2013
(86) PCT No.: PCT/JP2013/002676

§ 371 Date: Oct. 16, 2014

(30) Foreign Application Priority Data
Apr. 26, 2012 (JP) 2012-101125

(51) Int. Cl. H04N 5/225

(52) U.S. Cl. CPC H04N 5/2256
USPC 348/371

(57) ABSTRACT

A strobe device according to the present invention includes: a strobe main body; a light emitter; a vertical direction changer that includes a first driver that drives the light emitter in a vertical direction and that includes a vertical direction angle detector that detects vertical direction angle information; a horizontal direction changer that includes a second driver that drives the light emitter in a horizontal direction and that includes a horizontal direction angle detector that detects horizontal direction angle information; a distance measurer that obtains distance information; an imager; a subject recognizer that generates subject recognition information; and a drive controller. The drive controller controls operations of the first driver and the second driver, based on the vertical direction angle information, the horizontal direction angle information, the distance information, and the subject recognition information. With this, the strobe device that does not miss a photo opportunity even when the subject is moving is realized.

This application is a U.S. National Phase Application of PCT International Application PCT/JP2013/002676.

### TECHNICAL FIELD

The present invention relates to a strobe device mounted on an imaging device that captures an image of a subject, and relates in particular to an imaging device that automatically controls an irradiation direction of strobo light emitted from a flash discharge tube of a light emitter and an imaging device provided with the strobe device.

### BACKGROUND ART

Conventionally, multiple light stroboscopic imaging is performed on the subject using a plurality of strobe devices each of which is mounted on the imaging device that captures an image of a subject. At this time, each of the strobe devices is disposed in an appropriate direction with respect to the subject, for example, on a front surface side, a back surface side, a vertical direction side, and a horizontal direction side of the subject.

However, when stroboscopic imaging is performed using a plurality of strobe devices, a photographer needs to adjust an irradiation direction of each of the strobe devices. Therefore, the photographer needs to change, by moving close to the strobe device to be adjusted, the irradiation direction of the corresponding strobe device to a desired direction.

Conventionally, in order to obtain a more natural image, bounce imaging is performed on the subject by indirectly illuminating the subject through irradiating a reflection body such as the ceiling or walls with strobo light from the light emitter of the strobe device and then diffusing the strobo light. However, even in the bounce imaging, when a bounce state is adjusted, the photographer needs to move to the strobe device to be adjusted, as similar to the multiple light stroboscopic imaging. It should be noted that a normal bounce imaging is performed by, without facing an opening part of the light emitter of the strobe device with the subject, irradiating light emitted from the light emitter in a desired direction in which a reflection body such as the ceiling or walls is located.

In view of this, there is proposed a strobe device that automatically controls, through a controller, a bounce angle formed by an imaging direction that is an optical axis direction of an imaging lens and an irradiation direction that irradiates strobo light (a desired direction in which the reflection body is located) so that the light emitter can always irradiate strobo light in a direction in which the reflection body is located (for example, see Patent Literature (PTL) 1).

Moreover, from a viewpoint of tracking a moving subject (irradiation target such as a person), there is proposed an automatic tracking lighting device that automatically controls an irradiation direction as an illumination unit in a venue such as a stage (for example, see Patent Literature (PTL) 2).

However, the imaging device having the strobe device as described in PTL 1 performs autofocus ranging by directing the imaging lens of the imaging device toward each of the reflection body and the subject. Then, the imaging device is configured such that a bounce angle of the strobe device included in the imaging device is set, based on a distance between the reflection body and the subject. Therefore, PTL 1 does not disclose the strobe device mounted on the imaging device that captures the image of the subject, or an independent and single strobe device that is used as one of the strobe devices when multiple light stroboscopic imaging is performed.

Moreover, the automatic tracking lighting device disclosed in PTL 2 includes, as a basic configuration, an illumination unit that controls an irradiation direction by being set and driven independently, and an imager that controls an imaging direction. Moreover, the automatic tracking lighting device is configured to perform tracking control such that the irradiation direction and the imaging direction are facing the subject, based on coordinate identification information of the subject (irradiation target) obtained from an image of the imager. Therefore, PTL 2 does not disclose the strobe device mounted on the imaging device that captures the image of the subject, or a plurality of independent and single strobe devices in the multiple light stroboscopic imaging.

Therefore, in multiple light stroboscopic imaging using strobe devices and illumination units or bounce imaging, both PTL 1 and PTL 2 require the photographer to move to the strobe device or the illumination unit every time when the subject is moved based on the intention of the photographer and then the strobe device or the irradiation direction of the illumination unit itself is adjusted and changed. Therefore, it takes time to set the strobe device and the illumination unit in the multiple light stroboscopic imaging or the like. As a result, there is a problem that a photo opportunity is missed.

### CITATION LIST

### Patent Literature

PTL 1: Unexamined Japanese Patent Application Publication No. 2009-163179

PTL 2: Japanese Patent No. 3,271,900

### SUMMARY OF THE INVENTION

In order to solve the aforementioned problem, a strobe device according to the present invention includes: a strobe main body mounted on an imaging device that captures an image of a subject; a light emitter; a vertical direction changer that changes an angle in a vertical direction of the light emitter, the vertical direction changer including a first driver that drives the light emitter in the vertical direction; and a horizontal direction changer that changes an angle in a horizontal direction of the light emitter, the horizontal direction changer including a second driver that drives the light emitter in the horizontal direction. Furthermore, the strobe device further includes a distance measurer that obtains distance information indicating a distance to the subject; an imager that captures an image of an imaging area including the subject; a subject recognizer that generates subject recognition information that identifies and recognizes the subject from image information of the imaging area captured by the imager; and a drive controller that controls, according to movement of the subject, an angle in the vertical direction and an angle in the horizontal direction of the light emitter with respect to the strobe main body. Moreover, the vertical direction changer further includes a vertical direction angle detector that detects vertical direction angle information of the light emitter in the vertical direction, the horizontal direction changer further includes a horizontal direction angle detector that detects horizontal direction angle information of the light emitter in the horizontal direction, and the drive controller controls operations of the first driver and the second driver, based on the vertical direction angle information and the horizontal direction angle information of the light emitter, the distance information and the subject recognition information.

With this, in the strobe device that can automatically control an irradiation direction of strobo light in a desired direction, it is possible to change and set the irradiation direction of the strobo light from the irradiation direction set with respect to the current subject position to the irradiation direction with respect to the subject position after the movement, after tracking of the subject movement. As a result, it is possible to realize a strobe device that does not miss a photo opportunity.

Moreover, it is possible to arbitrarily change, through an operation of the photographer, the irradiation direction of the strobo light to a desired irradiation direction that is suitable for the current subject position by remote control using radio waves, for example. Therefore, when imaging is performed at a location away from the strobe device, the photographer can change the irradiation direction of the strobe device to a predetermined direction corresponding to the subject before movement, without moving to the location in which the strobe device is set. With this, especially in the case of the imaging device having a plurality of strobe devices, it is possible to change an irradiation direction angle of each of the strobe devices from a remote position. As a result, it is possible to significantly reduce preparation time in imaging.

Moreover, the imaging device according to the present invention includes the aforementioned strobe device. With this, it is possible to realize the imaging device that can capture the subject at an appropriate timing without missing a photo opportunity and without decreasing operability and workability.

### BRIEF DESCRIPTION OF DRAWINGS

FIG. 1 is a schematic side view illustrating a configuration of a strobe device according to a first exemplary embodiment of the present invention.

FIG. 2 is a schematic top view illustrating a configuration of the strobe device according to the present exemplary embodiment.

FIG. 3A is a diagram explaining an irradiation range in a vertical direction that can be set by the strobe device according to the present exemplary embodiment.

FIG. 3B is a diagram explaining an irradiation range in a horizontal direction that can be set by the strobe device according to the present exemplary embodiment.

FIG. 4A is a schematic view illustrating an imaging state from the top when multiple light stroboscopic imaging is performed using the strobe device according to the present exemplary embodiment.

FIG. 4B is a diagram of a captured image according to the present exemplary embodiment.

FIG. 5 is a schematic side view illustrating a configuration of a strobe device according to a second exemplary embodiment of the present invention.

### DESCRIPTION OF EMBODIMENTS

The following describes a strobe device according to exemplary embodiments of the present invention and an imaging device provided with the strobe device with reference to the drawings. It should be noted that the following exemplary embodiments are mere examples of the present invention, and are not intended to limit the technical scope of the present invention.

### First Exemplary Embodiment

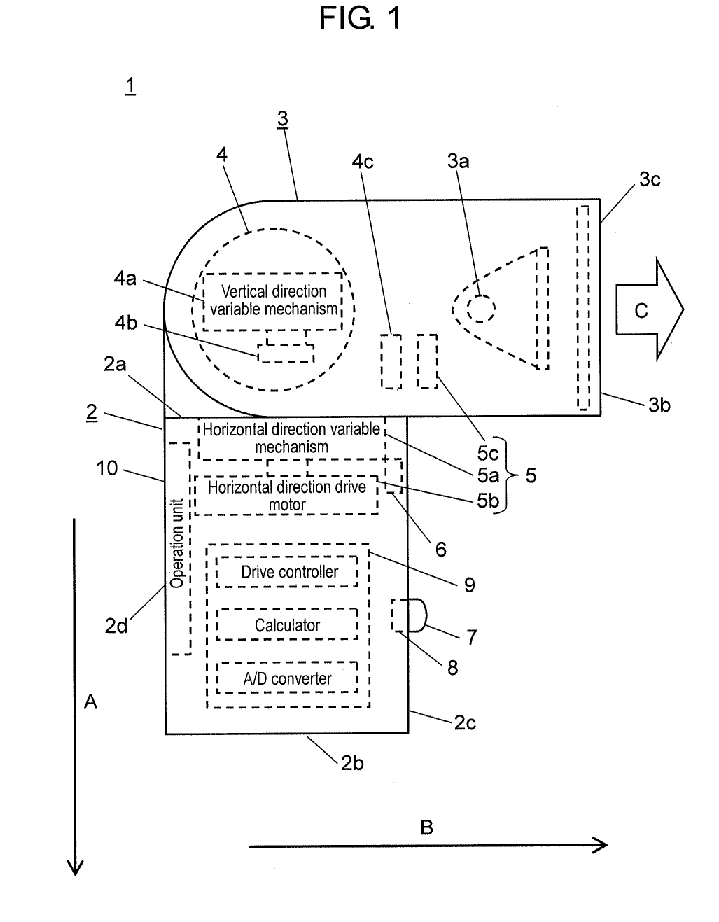

The following describes a strobe device according to the present exemplary embodiment of the present invention and an imaging device provided with the strobe device with reference to FIGS. 1 to 3B.

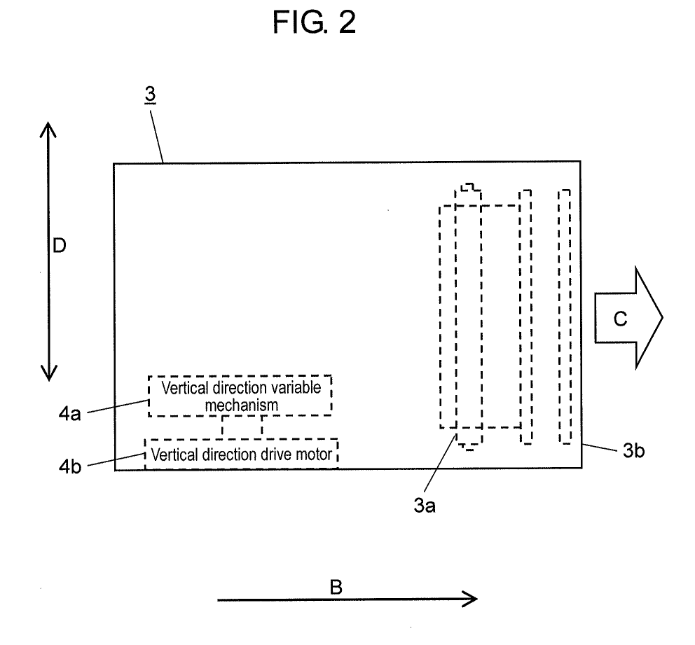

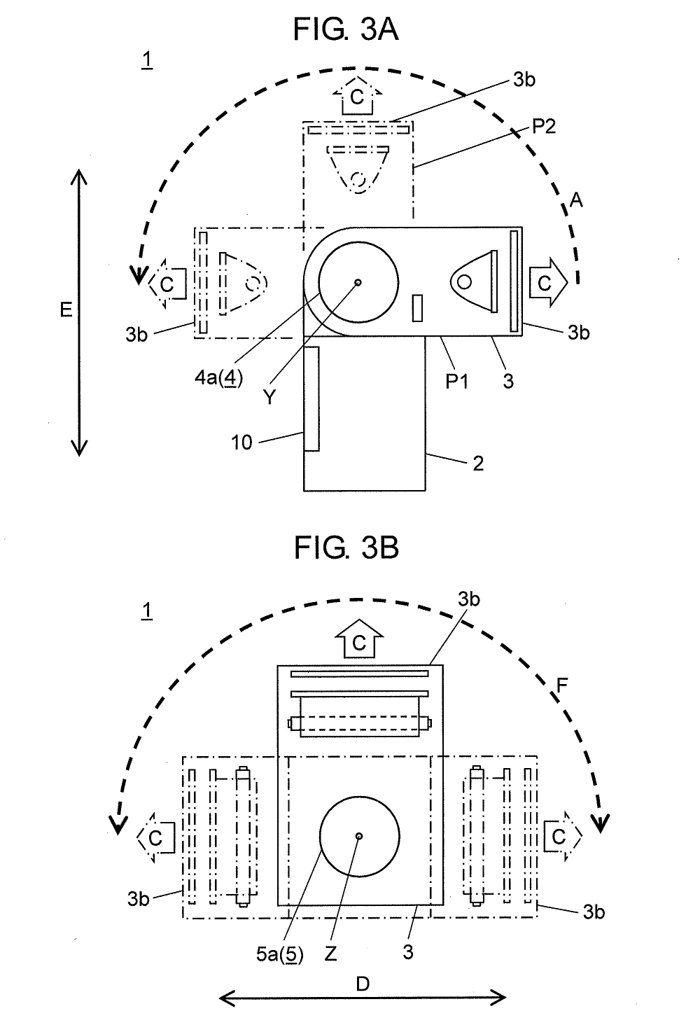

FIG. 1 is a schematic side view illustrating a configuration of a strobe device according to a first exemplary embodiment of the present invention. FIG. 2 is a schematic top view illustrating a configuration of the strobe device according to the present exemplary embodiment. FIG. 3A is a diagram explaining an irradiation range in a vertical direction that can be set by the strobe device according to the present exemplary embodiment. FIG. 3B is a diagram explaining an irradiation range in a horizontal direction that can be set by the strobe device according to the present exemplary embodiment.

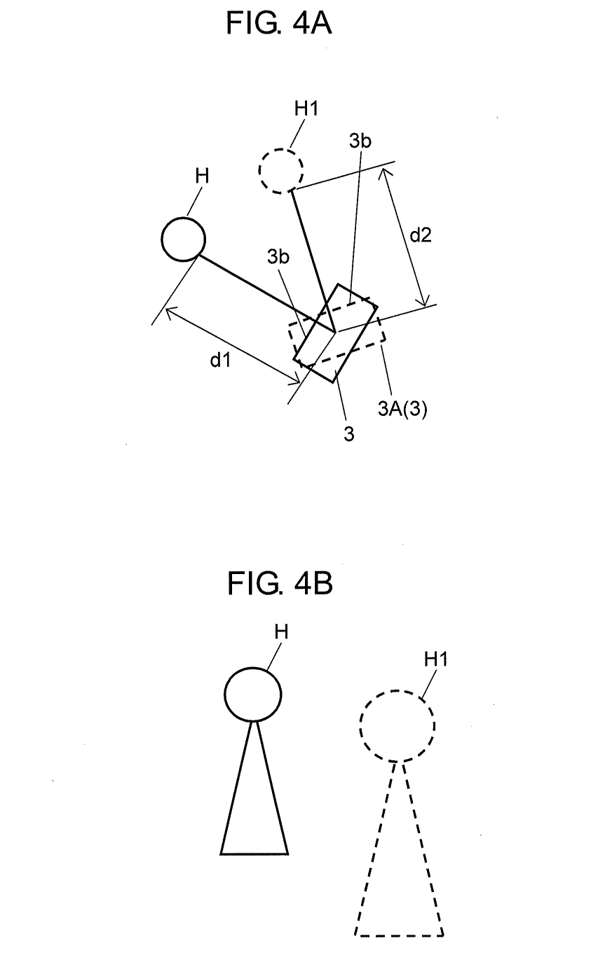

As illustrated in FIG. 1, strobe device 1 according to the present exemplary embodiment at least includes, for example, strobe main body 2 composed of a housing in a rectangular shape, and light emitter 3. Light emitter 3 is connected to strobe main body 2 such that light emitter 3 can be rotated in a vertical direction and a horizontal direction with respect to strobe main body 2. Light emitter 3 irradiates light emitted from flash discharge tube 3a that is embedded, as strobo light, to outside such as subject H (see FIG. 4A).

Moreover, the strobe device 1 includes vertical direction changer 4 that changes a vertical direction angle of the light emitter 3. Vertical direction changer 4 includes vertical direction variable mechanism 4a, first driver 4b (vertical direction drive motor), vertical direction angle detector 4c, and the like. Vertical direction variable mechanism 4a can move light emitter 3 with respect to strobe main body 2 in a vertical direction. First driver 4b drives vertical direction variable mechanism 4a. Vertical direction angle detector 4c detects a vertical direction angle of light emitter 3, and outputs and stores vertical direction angle information.

Strobe device 1 includes horizontal direction changer 5 that changes a horizontal direction angle of light emitter 3. Horizontal direction changer 5 includes horizontal direction variable mechanism 5a, second driver 5b (horizontal direction drive motor), horizontal direction detector 5c, and the like. Horizontal direction variable mechanism 5a can move light emitter 3 with respect to strobe main body 2 in a horizontal direction. Second driver 5b drives horizontal direction variable mechanism 5a. Horizontal direction angle detector 5c detects a horizontal direction angle of light emitter 3, and outputs and stores horizontal direction angle information.

Furthermore, strobe device 1 includes distance measurer 6, imager 7, subject recognizer 8, and drive controller 9. Distance measurer 6 is provided in strobe main body 2 or light emitter 3, and obtains distance information indicating a distance to subject H. Imager 7 is provided in strobe main body 2, and captures an image of an imaging area including subject H. Subject recognizer 8 identifies and recognizes subject H from image information in the imaging area captured by imager 7, and generates subject recognition information. Drive controller 9 controls the operations of first driver 4b and second driver 5b, based on vertical direction angle information and horizontal direction angle information of light emitter 3, distance information and subject recognition information. With this, it is possible to control the vertical direction angle and the horizontal direction angle of light emitter 3 with respect to strobe main body 2 according to the movement of subject H.

Moreover, as illustrated in FIG. 1, light emitter 3 is connected to upper surface 2a side of strobe main body 2 such that light emitter can be rotated. Furthermore, a connection part X (not illustrated) to be connected to the imaging device is provided on lower surface 2b side of strobe main body 2. Moreover, front surface 2c of strobe main body 2 is connected to the imaging device via the connection part X to be directed toward an imaging direction B of the imaging device (optical axis direction of the imaging lens).

Moreover, light emitter 3 is composed of a housing in an almost rectangular shape (including a rectangular shape). Light emitter 3 includes, on one surface 3c side of the housing, opening part 3b that irradiates light emitted from flash discharge tube 3a to subject H. Light emitter 3 changes an irradiation direction C in which strobo light is irradiated by changing, via vertical direction changer 4, an inclined angle with respect to a vertical direction A of opening part 3b.

As illustrated in FIG. 3A and FIG. 3B, vertical direction changer 4 and horizontal direction changer 5 of strobe device 1 connect between strobe main body 2 and light emitter 3 such that strobe main body 2 and light emitter 3 can be rotated.

Specifically, vertical direction changer 4 (see FIG. 2), as described above, includes vertical direction variable mechanism 4a that can be rotated in a vertical direction A around a horizontal axis Y provided along a cross direction D of strobe main body 2 (see FIG. 2), and first driver 4b that drives vertical direction variable mechanism 4a.

Moreover, vertical direction variable mechanism 4a, as illustrated in FIG. 3A, is provided such that an angle in a vertical direction A of light emitter 3 is rotated from 0 degrees to 180 degrees, for example. In other words, vertical direction variable mechanism 4a has a rotation angle of 180 degrees in a vertical direction A by including a normal irradiation angle (an angle when light emitter 3 is located at normal imaging position P1) and a desired irradiation direction angle that is different from the normal irradiation direction angle (for example, an angle when light emitter 3 is located at bound imaging position P2) and that is set by the photographer (user), for example.

Meanwhile, horizontal direction changer 5 (see FIG. 1) includes horizontal direction variable mechanism 5a that can be rotated in a horizontal direction F around a vertical axis Z provided in a vertical direction E (height direction) of strobe main body 2, and second driver 5b that drives horizontal direction variable mechanism 5a.

Horizontal direction variable mechanism 5a, as illustrated in FIG. 3B, is provided such that light emitter 3 is rotated in a left and right direction in a horizontal direction F, that is, in angles from 0 degrees to 180 degrees, for example.

Moreover, as described with reference to FIG. 1, vertical direction changer 4 includes first driver 4b that is a vertical direction drive motor that drives vertical direction variable mechanism 4a, and vertical direction angle detector 4c including a three-axis acceleration sensor that detects acceleration in three directions of X, Y, and Z axes, for example. Vertical direction changer 4 has a function of detecting and outputting vertical direction angle information. Here, the three-axis acceleration sensor detects, by detecting gravitational acceleration during rest, an irradiation direction angle in a vertical direction of light emitter 3 (orientation of the light emitter 3). It should be noted that other than the three-axis acceleration sensor, a volume configuration (for example, variable resistor) of detecting a relative rotation position in a vertical direction of light emitter 3 with respect to strobe main body 2 may be used as vertical direction angle detector 4c.

Meanwhile, horizontal direction changer 5 includes second driver 5b that is a horizontal direction drive motor that drives horizontal direction [symbol] variable mechanism 5a, and horizontal direction angle detector 5c including a geomagnetic sensor that detects a magnitude and direction of a magnetic field. Horizontal direction changer 5 has a function of detecting and outputting horizontal direction angle information. Here, the geomagnetic sensor detects, by detecting an orientation of the light emitter, an irradiation direction angle in a horizontal direction of light emitter 3 (orientation of light emitter 3). It should be noted that other than the geomagnetic sensor, a volume configuration (for example, variable resistor) of detecting a relative rotation position in a horizontal direction of light emitter 3 with respect to strobe main body 2 may be used as horizontal direction angle detector 5c.

Moreover, distance measurer 6 illustrated in FIG. 1 is provided in strobe main body 2 (or light emitter 3), and obtains distance information indicating a distance to the subject in a publicly known method, for example, of emitting a small amount of light toward the subject and measuring time until the light is reflected by the subject and returns.

Imager 7 is provided on front surface 2c side of strobe main body 2, and captures an image of an imaging area including the subject. Then, imager 7 outputs, as image information, an image signal of the imaging area on a regular still image basis or a moving picture basis.

Subject recognizer 8 generates subject recognition information that identifies and recognizes the subject from image information in the imaging area captured by imager 7. Specifically, first, subject recognizer 8 recognizes and stores a figure (shape) of the subject from the image information, for example. The subject recognition information (for example, information that a moving object in the imaging area is a target) is generated, by calculation, from a size of the shape in the aforementioned imaging area of an imaging screen at this time and a position of a storage area. It should be noted that subject recognizer 8 regularly obtains and calculates image information for generating the subject recognition information.

Drive controller 9 illustrated in FIG. 1 controls the operations of first driver 4b and second driver 5b, based on vertical direction angle information and horizontal direction angle information of light emitter 3, distance information and subject recognition information. With this, it is possible to control the vertical direction angle and the horizontal direction angle of light emitter 3 with respect to strobe main body 2 according to the movement of the subject.

Moreover, operation unit 10 illustrated in FIG. 1 is provided on back surface 2d side of strobe main body 2, and includes a function of setting an angle in a vertical direction and an angle in a horizontal direction of light emitter 3 with respect to strobe main body 2. Specifically, for example, before imaging is started, it is possible to set, at operation unit 10, a vertical direction angle and a horizontal direction angle of light emitter 3 to an angle that corresponds to the current position of the subject before movement and that is arbitrarily determined by the intention of the photographer.

Furthermore, operation unit 10 of strobe device 1 according to the present exemplary embodiment has a function of being able to set for switching an operation mode. In other words, as the operation mode, it is possible to set an automatic tracking mode to be described in detail later, and a normal bounce imaging mode. The normal bounce imaging mode, although not described in detail, is a mode in which drive controller 9 is controlled only by the operation of operation unit 10, and an irradiation direction of light emitter 3 is controlled to a direction intended by the photographer, that is, for example, a direction in which the photographer is facing the subject or another arbitrary direction. In this case, the normal bounce imaging mode assumes an automatic bounce imaging mode in which the irradiation direction of light emitter 3 is automatically controlled, in a response to the change, when the positional relationship between the strobe device and the subject is changed due to a change of the imaging position.

In strobe device 1 according to the present exemplary embodiment, assuming one of the two modes that are the automatic tracking mode and the normal bounce imaging mode, drive controller 9 is controlled based on the vertical direction angle information and the horizontal direction angle information of light emitter 3, the distance information and the subject recognition information. With this, the vertical direction angle and the horizontal direction angle of light emitter 3 with respect to strobe main body 2 are controlled according to the movement of the subject.

As described above, strobe device 1 according to the present exemplary embodiment and the imaging device provided with strobe device 1 are configured.

Next, an operation of the automatic tracking mode in which the subject of strobe device 1 according to the present exemplary embodiment is automatically tracked is described with reference to FIG. 4A and FIG. 4B. It should be noted that the following describes the case where the multiple light stroboscopic imaging is performed as an example of operation.

FIG. 4A is a schematic view illustrating an imaging state from the top when multiple light stroboscopic imaging is performed using the strobe device according to the present exemplary embodiment. FIG. 4B is a diagram of a captured image according to the present exemplary embodiment.

First, when the multiple light stroboscopic imaging is performed, an initial state of strobe device 1 is set. In other words, light emitter 3 controls an irradiation direction of light emitter 3 via operation unit 10 at drive controller 9 such that an illumination state intended by the photographer can be realized in a positional relationship with subject H as illustrated in FIG. 4A. With this, an initial state of strobe device 1 is set.

At this time, vertical direction angle detector 4c and horizontal direction angle detector 5c output vertical direction angle information and horizontal direction angle information, respectively, of light emitter 3 with respect to strobe main body 2 in the set initial state. Furthermore, vertical direction angle detector 4c and horizontal direction angle detector 5c store the set initial state as reference angle information, and provide the reference angle information to drive controller 9.

Moreover, distance measurer 6 and imager 7 operate simultaneously. Specifically, as illustrated in FIG. 4A, when light emitter 3 is controlled by the photographer to face subject H, distance measurer 6 measures a distance d1 to the subject H and outputs the distance d1 as distance information, and stores the distance information. At this time, imager 7 generates an image of an imaging area including subject H as illustrated in FIG. 4B, that is, information of the image in which subject H is located on the front surface.

Imager 7 outputs the image information in the imaging area to subject recognizer 8. At this time, subject recognizer 8 detects, from the generated (inputted) image information, a shape and a position of subject H within the image. With this, subject recognizer 8 generates and stores subject recognition information that identifies and recognizes subject H.

It should be noted that the operations of aforementioned distance measurer 6 and imager 7 are repeated at a predetermined timing, for example, by setting the automatic tracking mode at operation unit 10 to be described later. The distance information and the subject recognition information corresponding to subject H in an initial state are provided to drive controller 9.

Although the above describes, as an initial state, a state in which light emitter 3 faces subject H, the initial state is not limited to such. For example, a state in which light emitter 3 is not facing subject H for obtaining a desired bounce state may be set as the initial state.

Next, after the aforementioned initial state is set, the photographer (user) sets the automatic tracking mode using operation unit 10. With this, the preparation for the multiple light stroboscopic imaging is completed, and the photographer can perform actual imaging.

The following describes an operation of strobe device 1 when subject H is moved by the intention of the photographer, for example, while the multiple light stroboscopic imaging is performed. Specifically, a description is given to the case where the current position of subject H illustrated in a solid line in FIG. 4A is moved to the position of subject H1 illustrated in a dotted line.

As described above, distance measurer 6 and imager 7 of strobe device 1 repeat the operations at a predetermined timing. Therefore, as illustrated in FIG. 4A, in a response to the movement of subject H, distance measurer 6 measures a distance d2 to subject H1 after the movement, and outputs the distance d2 as the distance information and stores the distance information.

Imager 7 generates image information in the imaging area, and outputs the image information to subject recognizer 8. Subject recognizer 8 detects a shape and a position within the captured image of subject H1 as illustrated in a dotted line in FIG. 4B based on the image information from imager 7, and generates the shape and the position as the subject recognition information after the movement and stores the subject recognition information.

The distance information and the subject recognition information after the movement of the subject are provided to drive controller 9. At this time, drive controller 9 receives, as reference angle information indicating the initial state, vertical direction angle information and horizontal direction angle information of light emitter 3 with respect to strobe main body 2 that are detected by vertical direction angle detector 4c and horizontal direction angle detector 5c, respectively, when the initial state is set. In view of this, drive controller 9 performs a calculation by including the reference angle information indicating the initial state and the distance information and the subject recognition information of subject H1 after the movement. Then, drive controller 9 generates and outputs movement angle information in a vertical direction and a horizontal direction of light emitter 3. With this, the states of subject H1 and light emitter 3 that are set at the initial state and that are according to the intention of the photographer can be set with respect to subject H1 after the movement.

At this time, the movement angle information of light emitter 3 that is formed and outputted by drive controller 9 is specifically a drive control signal for operating first driver 4b and second driver 5b. Based on the movement angle information outputted by drive controller 9, first driver 4b and second driver 5b are driven and vertical direction variable mechanism 4a and horizontal direction variable mechanism 5a are started. With this, light emitter 3 is driven in a vertical direction and a horizontal direction. As a result, for example, light emitter 3 is driven at a position as illustrated in a dotted line 3A in FIG. 4A.

In other words, by the movement of light emitter 3, a relationship between light emitter 3 and subject H1 after the movement is maintained at a relationship between subject H and light emitter 3 at the initial state set by the photographer. As a result, the irradiation direction of strobo light of light emitter 3 is changed by tracking the movement of subject H.

As described above, it is possible to realize strobe device 1 that can change an angle of the light emitter by tracking the movement of the subject, and the imaging device provided with strobe device 1.

It should be noted that in the aforementioned exemplary embodiment, although the example of the case has been described where strobe device 1 is provided with operation unit 10, the case is not limited to such and a configuration is acceptable in which operation unit 10 is omitted. In this case, for example, it is configured such that the automatic tracking mode is always set by the input of a power switch that starts the operation of strobe device 1. The configuration is acceptable in which before the input of a power switch, the photographer manually sets the initial state of light emitter 3 by directly holding light emitter 3. With this, it is possible to image the subject without missing a photo opportunity, by quickly setting the initial state of light emitter 3.

### Second Exemplary Embodiment

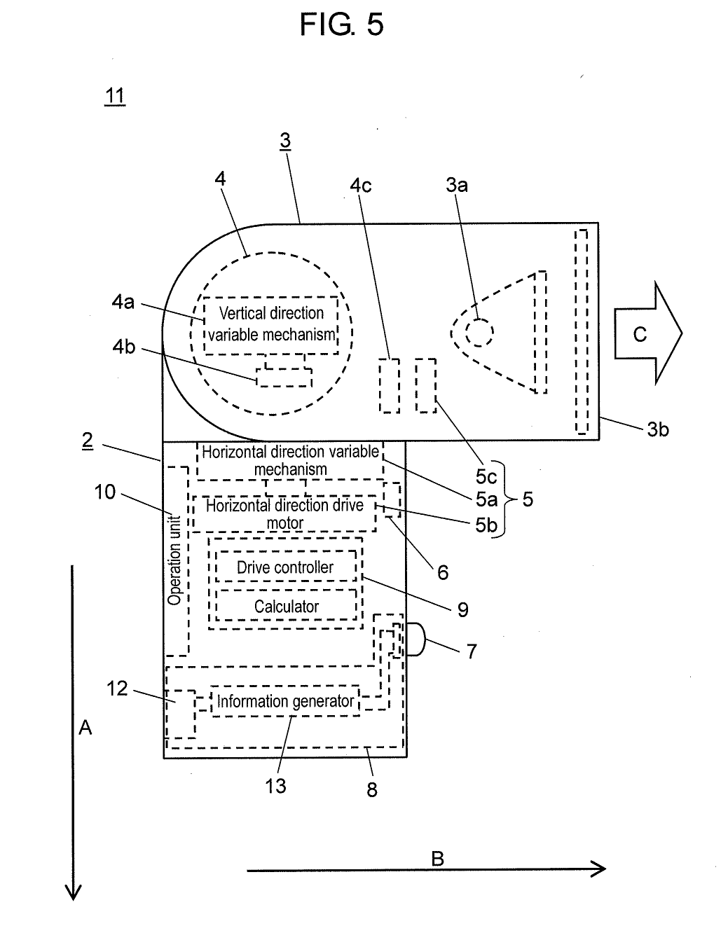

The following describes a strobe device according to a second exemplary embodiment of the present invention with reference to FIG. 5.

FIG. 5 is a schematic side view illustrating a configuration of the strobe device according to the second exemplary embodiment.

A difference of strobe device 11 according to the present exemplary embodiment from strobe device 1 according to the first exemplary embodiment is that subject recognizer 8 is further provided with display part 12 and information generator 13. It should be noted that the same reference marks are assigned to the same components as those of strobe device 1 according to the first exemplary embodiment and a description is omitted for components of the present exemplary embodiment that are the same as in the first exemplary embodiment.

In other words, as illustrated in FIG. 5, display part 12 of strobe device 11 according to the present exemplary embodiment is provided in strobe main body 2 and displays an image captured by the imager 7. Moreover, information generator 13 has a function of generating subject recognition information that identifies and recognizes the subject, in response to contact made on an image part of the subject displayed in display part 12.

The following describes, with reference to FIG. 4A and FIG. 4B, the operation of strobe device 11 when subject H is moved by the intention of the photographer, for example, while multiple light stroboscopic imaging is performed.

It should be noted that since strobe device 11 according to the present exemplary embodiment also includes aforementioned subject recognizer 8, the operation when multiple light stroboscopic imaging is performed is basically the same as strobe device 1 according to the first exemplary embodiment.

In other words, first, as similar to the first exemplary embodiment, an initial state of strobe device 11 is set. In other words, light emitter 3 controls the irradiation direction of light emitter 3 via operation unit 10 at drive controller 9 such that an illumination state intended by the photographer can be realized in a positional relationship with subject H as illustrated in FIG. 4A. With this, an initial state of strobe device 11 is set.

At this time, vertical direction angle detector 4c and horizontal direction angle detector 5c output vertical direction angle information and horizontal direction angle information, respectively, with respect to strobe main body 2 of light emitter 3 at the set initial state. Furthermore, vertical direction angle detector 4c and horizontal direction angle detector 5c store the set initial state as reference angle information, and provide the reference angle information to drive controller 9.

Moreover, distance measurer 6 and imager 7 operate simultaneously. Specifically, as illustrated in FIG. 4A, distance measurer 6 measures a distance d1 to subject H and outputs and stores the distance d1 as distance information. At this time, imager 7 generates an image of the imaging area including subject H as illustrated in FIG. 4B, that is, image information in which subject H is located on the front surface.

Next, the image information of the aforementioned imaging area is provided to display part 12 of subject recognizer 8. Then, display part 12 displays the image of the imaging area including subject H as illustrated in FIG. 4B.

At this time, subject H is identified by contacting the image part of subject H within the image information displayed by display part 12. With this, the subject recognition information is generated when subject H is identified and recognized by the operation of information generator 13.

In other words, strobe device 11 according to the present exemplary embodiment generates the subject recognition information by the operation, by information generator 13, of contacting and identifying a subject image part within the image displayed by display part 12. This is the difference from the first exemplary embodiment in which subject recognition information is generated from a shape and a position within the image of subject H.

It should be noted that the operations of aforementioned distance measurer 6 and imager 7 are repeated at a predetermined timing, for example, as similar to the first exemplary embodiment. Then, the distance information and the subject recognition information corresponding to subject H at the initial state are provided to drive controller 9.

With this, the initial state of strobe device 11 is set.

Next, when the initial state is set as described above, the photographer (user) sets the automatic tracking mode at operation unit 10. With this, the preparation for multiple light stroboscopic imaging is completed and the photographer can perform actual imaging.

The following describes the operation of strobe device 11 when subject H is moved by the intention of the photographer, for example, while multiple light stroboscopic imaging is performed. Specifically, a description is given to the case where the current position of subject H as illustrated in a solid line in FIG. 4A is moved to the position of subject H1 as illustrated in a dotted line.

First, as similar to the first exemplary embodiment, distance measurer 6 of strobe device 11, as illustrated in FIG. 4A, in a response to the movement of subject H, measures a distance d2 to subject H1 after the movement, and outputs and stores the distance d2 as distance information.

Moreover, imager 7 generates image information including subject H1 after the movement as illustrated in a dotted line in FIG. 4B.

At this time, in strobe device 11 according to the present exemplary embodiment, subject H is identified on the image at the initial state by display part 12 and information generator 13 of subject recognizer 8. In view of this, by tracking the movement of the subject, the information based on subject H1 after the movement is generated and stored as the subject recognition information.

Then, the distance information and the subject recognition information after the movement of the subject are provided to drive controller 9.

Next, drive controller 9 operates in the same manner as that in the first exemplary embodiment. In other words, based on various types of information that are provided, drive controller 9 generates and outputs movement angle information of light emitter 3 in a vertical direction and a horizontal direction. With this, the states of subject H1 and light emitter 3 that are set at the initial state and that are according to the intention of the photographer can be set with respect to subject H1 after the movement.

Based on the movement angle information outputted by drive controller 9, first driver 4b and second driver 5b are driven and vertical direction variable mechanism 4a and horizontal direction variable mechanism 5a are started. With this, light emitter 3 is driven in a vertical direction and a horizontal direction.

In other words, by the movement of light emitter 3, a relationship between light emitter 3 and subject H1 after the movement is maintained at a relationship between subject H and light emitter 3 at the initial state set by the photographer. As a result, the irradiation direction of strobo light of light emitter 3 is changed by tracking the movement of subject H.

As described above, it is possible to realize strobe device 11 that can change an angle of the light emitter by tracking the movement of the subject, and the imaging device provided with strobe device 11.

It should be noted that the strobe device and the imaging device provided with the strobe device are not limited to the aforementioned exemplary embodiments, and various modification are possible without departing from the scope of the present invention.

In other words, although in the above exemplary embodiments, an example of the case has been described where in strobe device 1 and strobe device 11, operation unit 10 provided in strobe main body 2 is directly operated by the photographer (user), the case is not limited to such. For example, it is possible to provide, in light emitter 3 or strobe main body 2 of strobe device 1 and strobe device 11, a signal transmitter and receiver that transmits and receives a signal to and from outside, and to attach a remote control device, via the signal transmitter and receiver, that can perform remote control of operation unit 10. With this, operation is possible in a place away from an imaging device such as a camera and a strobe device.

In this case, the signal transmitter and receiver includes at least a receiver that receives, from the remote control device, a signal related to a desired irradiation direction angle. Furthermore, the remote control device includes an input interface such as operation button and operation lever for inputting information such as a desired irradiation direction angle, and a transmitter that transmits a signal, by light or radio waves, to the signal transmitter and receiver.

It should be noted that a communication standard between the remote control device and the signal transmitter and receiver is not limited to be wireless, and wired communication using communication cables is possible. At this time, the aforementioned remote control device is not limited to a dedicated device provided for performing remote control of light emitter 3. For example, it may be an information processing device such as an imaging device, a computer, a mobile phone, or a mobile information terminal in which a program for performing remote control of light emitter 3 is readable. Using a communication function provided in the information processing device, a configuration is possible in which the information processing device can communicate with strobe device 1 and strobe device 11. With this, the photographer (user) can remotely set a desired irradiation direction angle to operation unit 10. Moreover, independently of the current angles of strobe device 1 and strobe device 11, drive controller 9 can quickly change to a desired irradiation direction angle based on an angle in the vertical direction and an angle of the horizontal direction of the light emitter that are automatically detected by the vertical direction angle detector and the horizontal direction angle detector, respectively. At this time, the remote control device may communicate with the operation unit via the signal transmitter and receiver, and directly communicate with the drive controller not via operation unit 10.

Moreover, although the aforementioned exemplary embodiments have described an example of the case where the operation unit 10 of each of strobe device 1 and strobe device 11 is included in strobe main body 2, operation unit 10 is not limited to these. For example, operation unit 10 may be included in light emitter 3 or the imaging device. With this, since the operation unit can be set anywhere, it is possible to increase versatility.

Although an example of the case has been described where the maximum rotation range of vertical direction variable mechanism 4a is 180 degrees, the case is not limited to this. For example, the maximum rotation range of the vertical direction variable mechanism 4a may be 90 degrees. In this case, by combining with horizontal direction variable mechanism 5a, an angle of light emitter 3 in a vertical direction can be rotated up to 180 degrees around a horizontal axis from the normal irradiation position. In other words, when vertical direction variable mechanism 4a needs to be rotated from 90 to 180 degrees, horizontal direction variable mechanism 5a can be rotated 180 degrees in a vertical direction. With this, the configuration of the variable mechanism can be further simplified.

Moreover, although the aforementioned exemplary embodiments have described an example of the case where the irradiation direction of light emitter 3 can be set to a desired irradiation direction at operation unit 10 included in strobe main body 2, the irradiation direction setting is not limited to this.

For example, separately from strobe device 1, an external operation unit may be provided and the irradiation direction of the light emitter 3 may be set to a desired irradiation direction. With this, it is possible to increase operability and versatility.

As described above, the strobe device according to the present invention includes: a strobe main body mounted on an imaging device that captures an image of a subject; a light emitter; a vertical direction changer that changes an angle in a vertical direction of the light emitter, the vertical direction changer including a first driver that drives the light emitter in the vertical direction; and a horizontal direction changer that changes an angle in a horizontal direction of the light emitter, the horizontal direction changer including a second driver that drives the light emitter in the horizontal direction. Furthermore, the strobe device further includes a distance measurer that obtains distance information indicating a distance to the subject; an imager that captures an image of an imaging area including the subject; a subject recognizer that generates subject recognition information that identifies and recognizes the subject from image information of the imaging area captured by the imager; and a drive controller that controls, according to movement of the subject, an angle in the vertical direction and an angle in the horizontal direction of the light emitter with respect to the strobe main body. Moreover, the vertical direction changer further includes a vertical direction angle detector that detects vertical direction angle information of the light emitter in the vertical direction, the horizontal direction changer further includes a horizontal direction angle detector that detects horizontal direction angle information of the light emitter in the horizontal direction, and the drive controller controls operations of the first driver and the second driver, based on the vertical direction angle information and the horizontal direction angle information of the light emitter, the distance information and the subject recognition information.

With this configuration, when the subject moves, the drive controller drives the light emitter with respect to the strobe main body in a vertical direction and a horizontal direction, based on the vertical angle information and the horizontal angle information with respect to the strobe main body of the light emitter, the distance information of the subject, and the subject recognition information. As a result, it is possible to realize a strobe device that can change the irradiation direction of strobo light by the light emitter by tracking the movement of the subject.

Moreover, the subject recognizer may include a display part that displays the image captured by the imager, and an information generator that generates the subject recognition information in response to contact made on an image part of the subject displayed in the display part.

With this configuration, it is possible to generate the subject recognition information that can more definitely recognize the subject intended by the photographer. With this, it is possible to change the irradiation direction of strobo light by the light emitter by tracking the movement of the subject.

Moreover, in the strobe device according to the present invention, at least one of the strobe main body and the light emitter may include an operation unit that sets an irradiation direction angle of the light emitter to a desired direction by controlling operations of the first driver and the second driver.

With this configuration, it is possible to arbitrarily set, with respect to the subject before the movement, the irradiation direction of the light emitter intended by the photographer. With this, when the subject moves, it is possible to change the irradiation direction of strobo light by the light emitter by tracking the subsequent movement of the subject by setting the state set arbitrarily by the photographer as a reference.

Moreover, in the strobe device according to the present invention, the operation unit may be configured to be controllable from a remote location.

With this configuration, when multiple light stroboscopic imaging is performed, the photographer can arbitrarily set the irradiation direction of the light emitter as intended by the photographer with respect to the subject before the movement, without moving to the strobe device located away from the imaging device. With this, when the subject moves, it is possible to change the irradiation direction of strobo light by the light emitter by tracking the subsequent movement of the subject by setting the state arbitrarily set by the photographer as a reference.

Moreover, the strobe device according to the present invention may further include an external operation unit that can set an irradiation direction of the light emitter to a desired irradiation direction by remotely controlling the operation of the first driver and the second driver.

With this configuration, it is not necessary to set the operation unit at each strobe device to be remotely operated. With this, it is possible to miniaturize the strobe device and the photographer can arbitrarily set the irradiation direction of the light emitter as intended by the photographer with respect to the subject before the movement, without moving to the strobe device located away from the imaging device. As a result, when the subject moves, it is possible to change the irradiation direction of strobo light by the light emitter by tracking the subsequent movement of the subject by setting the state arbitrarily set by the photographer as a reference.

Moreover, the strobe device according to the present invention may include an external operation unit wirelessly transmits a control signal that controls the operations of the first driver and the second driver.

With this configuration, the photographer can remotely set a desired irradiation direction angle to the operation unit.

Moreover, the imaging device according to the present invention may include the aforementioned strobe device. With this, it is possible to realize the imaging device that can capture an image at an appropriate timing, without decreasing operability and workability and without missing a photo opportunity.

Moreover, the imaging device according to the present invention may include an operation unit that sets an irradiation direction angle of the light emitter of the strobe device to a desired direction. With this, it is possible to realize an imaging device having high versatility.

### INDUSTRIAL APPLICABILITY

Since the present invention makes it possible to remotely adjust an irradiation direction angle of a plurality of strobe devices, the present invention is useful in the technical field such as a strobe device that performs stroboscopic imaging using strobe devices and an imaging device.

### REFERENCE MARKS IN THE DRAWINGS

1 strobe device
2 strobe main body
2a upper surface
2b lower surface
2c front surface
2d back surface
3 light emitter
3a flash discharge tube
3b opening part
3c one surface
4 vertical direction changer
4a vertical direction variable mechanism
4b first driver
4c vertical direction angle detector
5 horizontal direction changer
5a horizontal direction variable mechanism
5b second driver
5c horizontal direction angle detector
6 distance measurer
7 imager
8 subject recognizer
9 drive controller
10 operation unit
11 strobe device
12 display part
13 information generator

1. A strobe device comprising:
a strobe main body mounted on an imaging device that captures an image of a subject;
a light emitter;
a vertical direction changer that changes an angle in a vertical direction of the light emitter, the vertical direction changer including a first driver that drives the light emitter in the vertical direction;
a horizontal direction changer that changes an angle in a horizontal direction of the light emitter, the horizontal direction changer including a second driver that drives the light emitter in the horizontal direction;
a distance measurer that obtains distance information indicating a distance to the subject;
an imager that captures an image of an imaging area including the subject;
a subject recognizer that generates subject recognition information that identifies and recognizes the subject from image information of the imaging area captured by the imager; and
a drive controller that controls, according to movement of the subject, an angle in the vertical direction and an angle in the horizontal direction of the light emitter with respect to the strobe main body,
wherein the vertical direction changer further includes a vertical direction angle detector that detects vertical direction angle information of the light emitter in the vertical direction,
the horizontal direction changer further includes a horizontal direction angle detector that detects horizontal direction angle information of the light emitter in the horizontal direction, and
the drive controller controls operations of the first driver and the second driver, based on the vertical direction angle information and the horizontal direction angle information of the light emitter, the distance information and the subject recognition information.

2. The strobe device according to claim 1,
wherein the subject recognizer includes a display part that displays the image captured by the imager, and an information generator that generates the subject recognition information in response to contact made on an image part of the subject displayed in the display part.

3. The strobe device according to claim 1,
wherein at least one of the strobe main body and the light emitter includes an operation unit that sets an irradiation direction angle of the light emitter to a desired direction.

4. The strobe device according to claim 3,
wherein the operation unit is configured to be controllable from a remote location.

5. The strobe device according to claim 1, further comprising
an external operation unit that is capable of remotely setting an irradiation direction of the light emitter to a desired irradiation direction.

6. The strobe device according to claim 5,
wherein the external operation unit wirelessly transmits a control signal that controls the operations of the first driver and the second driver.

7. An imaging device comprising the strobe device according to claim 1.

8. The imaging device according to claim 7, further comprising
an operation unit that sets an irradiation direction angle of the light emitter of the strobe device to a desired direction.
